(19) United States
(12) Patent Application Publication
(10) Pub. No.: US 2024/0136680 A1
(43) Pub. Date: Apr. 25, 2024

(54) BATTERY DEVICE

(71) Applicant: SK On Co., Ltd., Seoul (KR)

(72) Inventors: Jeong Joo LEE, Daejeon (KR); Tak Kyung YOO, Daejeon (KR)

(21) Appl. No.: 18/452,557

(22) Filed: Aug. 20, 2023

(30) Foreign Application Priority Data
Oct. 24, 2022 (KR) 10-2022-0138307

(51) Int. Cl. H01M 50/588; H01M 10/613; H01M 10/6554; H01M 10/6556; H01M 50/204; H01M 50/264; H01M 50/296; H01M 50/30; H01M 50/503; H01M 50/517; H01M 50/593

(52) U.S. Cl. CPC H01M 50/588; H01M 10/613; H01M 10/6554; H01M 10/6556; H01M 50/204; H01M 50/264; H01M 50/296; H01M 50/30; H01M 50/503; H01M 50/517; H01M 50/593

(57) ABSTRACT

A battery device including a plurality of cell stacks formed by stacking a plurality of battery cells and including terminal for external connection, a case accommodating the plurality of cell stacks therein, and at least one busbar assembly contacting the terminal of the plurality of cell stacks to electrically connect the plurality of cell stacks to each other, wherein the at least one busbar assembly is disposed in a bottom surface of the case, and wherein the plurality of cell stacks, having a bottom surface on which the terminal is disposed, is coupled to the busbar assembly, is disclosed.

### CROSS-REFERENCE TO RELATED APPLICATION(S)

This patent document claims the priority and benefits of Korean Patent Application No. 10-2022-0138307 filed on Oct. 25, 2022, the disclosure of which is incorporated herein by reference in its entirety.

### TECHNICAL FIELD

The present disclosure relates to a battery device capable of improving safety.

### BACKGROUND

Unlike primary batteries, secondary batteries may charge and discharge electricity to be applied to devices within various fields such as a digital camera, a mobile phone, a laptop computer, a hybrid vehicle, and an electric vehicle. Among secondary batteries, a large amount of research on lithium secondary batteries having high energy density and discharge voltage is in progress. The lithium secondary batteries may be manufactured as flexible pouched type battery cells, rigid prismatic battery cells, or cylindrical can type battery cells.

A plurality of battery cells may be stacked and electrically connected to each other, and may be mounted in a case in units of cell stacks to form a battery device. The battery device may be installed and used in an electric vehicle or the like.

However, in such a conventional battery device, when one cell stack is ignited, an external short circuit with another adjacent cell stack may occur, which may cause secondary ignition or explosion. Accordingly, there is a demand for a battery device capable of suppressing an external short circuit.

### SUMMARY

An aspect of the present disclosures is implemented in some embodiments to suppress occurrence of an external short circuit due to a flame or a high-temperature gas generated in a battery device.

In some embodiments of the present disclosures, a battery device includes a plurality of cell stacks formed by stacking a plurality of battery cells and including terminal for external connection, a case accommodating the plurality of cell stacks therein, and at least one busbar assembly contacting the terminal of the plurality of cell stacks to electrically connect the plurality of cell stacks to each other, wherein the at least one busbar assembly is disposed in a bottom surface of the case, and wherein the plurality of cell stacks, having a bottom surface on which the terminal is disposed, is coupled to the busbar assembly.

In the present embodiment, the busbar assembly may include a connection member formed of a conductive material and having both end portions contacting terminal of different cell stacks of the plurality of cell stacks, and an insulating body embedding the connection member therein, wherein only the both end portions of the connection member are exposed from the insulating body externally to contact the terminal.

In the present embodiment, the case may include a side wall portion forming an internal space, and a bottom plate covering a bottom portion of the internal space, and wherein the bottom plate includes a cooling plate including a first plate supporting the plurality of cell stacks, and a second plate coupled to the first plate to form a cooling flow path.

In the present embodiment, the cooling plate may include a fastening portion to which the at least one busbar assembly is coupled, and a cooling portion in which the cooling flow path is formed.

In the present embodiment, the bottom plate may further include a cover plate supporting a bottom portion of the cooling plate and coupled to the side wall portion.

In the present embodiment, a partition wall partitioning the internal space into a plurality of accommodation spaces may be further included, wherein the partition wall may be coupled to the fastening portion.

In the present embodiment, a partition wall partitioning the internal space into a plurality of accommodation spaces may be further included, wherein the partition wall may cross the busbar assembly and may be disposed in a top of the busbar assembly.

In the present embodiment, a venting flow path through which gas moves when the gas is discharged from the plurality of battery cells may be further included, wherein the venting flow path is formed as a space between the plurality of cell stacks or between the plurality of cell stacks and the case.

In the present embodiment, the plurality of cell stacks may be coupled to the busbar assembly to completely cover the both end portions of the connection member.

In the present embodiment, a top surface of the fastening portion may be disposed on a level higher than that of a top surface of the cooling portion.

In the present embodiment, the both end portions of the connection member may be disposed on a level higher than that of a top surface of the cooling portion.

In the present embodiment, an expansion partition wall coupled to the partition wall and extending a length of the partition wall may be further included, wherein the at least one busbar assembly may be disposed in a bottom of the expansion partition wall.

In the present embodiment, a fastening block disposed in the internal space, and disposed to overlap at least a portion thereof with the plurality of cell stacks; and a fastening member passing through the plurality of cell stacks and fastened to the fastening block may be further included.

In the present embodiment, the case may include a side wall portion forming an internal space; and a bottom plate covering a bottom portion of the internal space, wherein the bottom plate may include at least one cooling portion having a cooling flow path therein; and a fastening portion coupled to the at least one cooling portion and having an insertion groove into which the busbar assembly is inserted.

In the present embodiment, the at least one busbar assembly may include a member embedding portion in which the connection member is embedded, and insertion blocks formed thicker than the member embedding portion on both ends of the member embedding portion, wherein a through-hole may be formed in each of the insertion blocks, and the both end portions of the connection member may be disposed in different through-holes and exposed from the insulating body externally.

In the present embodiment, a fastening member inserted into the through-hole from a bottom portion of the fastening portion and fastening the connection member to each of the terminal may be further included.

In the present embodiment, in the connection member, the both end portions may be disposed on the same plane, and a portion embedded in the member embedding portion may be disposed on a plane different from the both end portions.

In the present embodiment, the connection member may be formed of a material having flexibility.

In the present embodiment, the connection member may include a wiring portion connecting the both end portions, wherein the wiring portion may be formed to be curved.

In the present embodiment, the cooling portion may be provided as a plurality of cooling portions, and the plurality of cooling portions may be disposed in a space partitioned by the fastening portion.

According to an aspect of the present disclosures, a terminal of a cell stack and a connection member may be coupled to each other on a bottom surface of a case. Therefore, it is possible to minimize occurrence of a short circuit on a top side of the cell stack. In addition, since a maximum space between cell stacks may be secured, a venting flow path may be expanded.

### BRIEF DESCRIPTION OF DRAWINGS

Certain aspects, features, and advantages of the disclosures may be illustrated by the following detailed description with reference to the accompanying drawings.

FIG. 1 is a perspective view schematically illustrating a battery device according to an embodiment of the disclosure of this patent document.

FIG. 2 is a partially exploded perspective view of FIG. 1.

FIG. 3 is a cross-sectional view of FIG. 1, taken along line I-I′.

FIG. 4 is an exploded perspective view of the bottom plate illustrated in FIG. 3.

FIG. 5 is a cross-sectional view of FIG. 1, taken along line II-II′.

FIG. 6 is a perspective view of the busbar assembly illustrated in FIG. 4.

FIG. 7 is a cross-sectional view of FIG. 6, taken along line III-III′.

FIG. 8 is a perspective view partially illustrating a fastening portion and a partition wall according to another embodiment of the disclosures.

FIGS. 9 and 10 are cross-sectional views of a battery device according to another embodiment of the disclosures, respectively.

FIG. 11 is a perspective view of the busbar assembly illustrated in FIGS. 9 and 10.

### DETAILED DESCRIPTION

Hereinafter, embodiments of the disclosures will be described in detail with reference to the accompanying drawings. In the accompanying drawings, some components may be exaggerated, omitted, or schematically illustrated, and a size of each component may not entirely reflect the actual size.

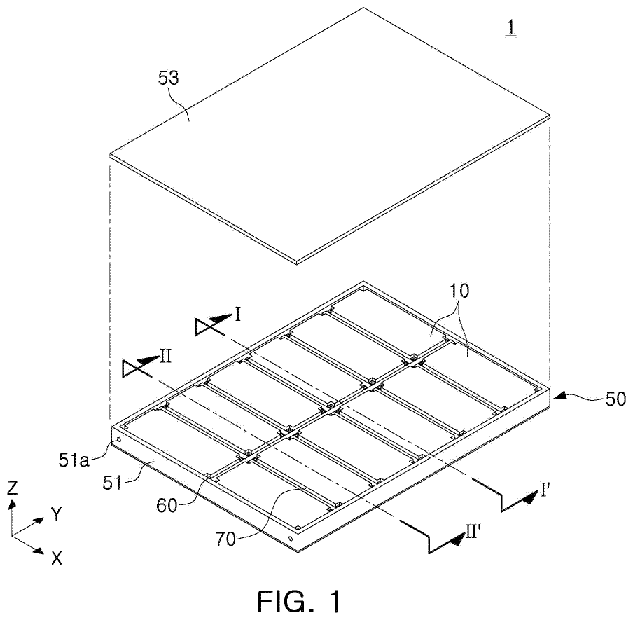

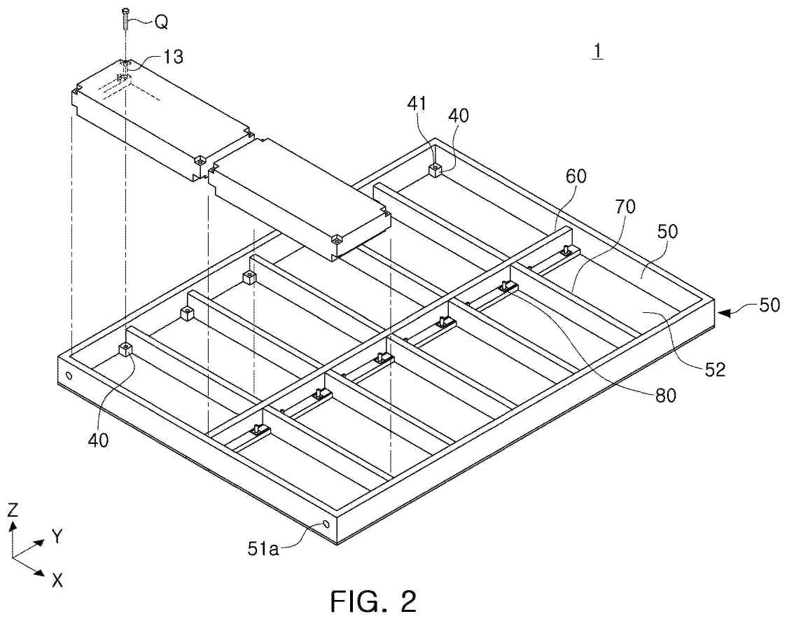

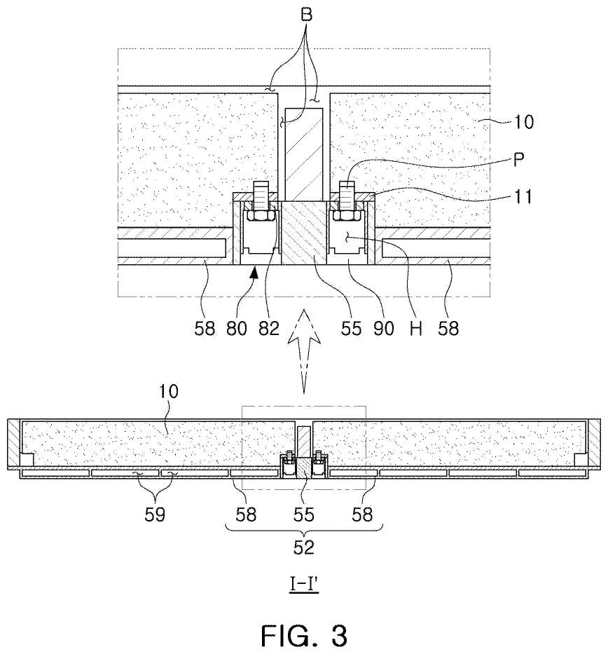

FIG. 1 is a perspective view schematically illustrating a battery device according to an embodiment of the disclosure of this patent document, and FIG. 2 is a partially exploded perspective view of FIG. 1. FIG. 3 is a cross-sectional view of FIG. 1, taken along line I-I′. For convenience of explanation, FIGS. 2 and 3 omits the top plate.

Referring to FIGS. 1 to 3, a battery device 1 according to an embodiment of the disclosures may include a plurality of cell stacks 10, a case 50, a partition wall (60 and 70), and a busbar assembly 80.

A cell stack 10 may include a secondary battery cell such as a lithium battery, a nickel-hydrogen battery, or the like, capable of charging and discharging electricity. Each of the cell stacks 10 may be formed in a substantially hexahedral shape by stacking a plurality of battery cells, and may be accommodated in the case or fixed in a stacked state by a bracket or the like.

At least one terminal (11 in FIG. 3) may be provided on one side surface of the cell stack 10. The terminal 11 may be a conductive member provided on the cell stack 10 to electrically connect the battery cells to an external source.

In the present embodiment, the terminal 11 may be disposed in at least one of both end portions of the cell stack 10 in a longitudinal direction (X-direction). In addition, one surface of the terminal 11 may be exposed from the cell stack 10 externally.

The terminal 11 may include a positive terminal and a negative terminal. The positive terminal and the negative terminal may be disposed in one end of the cell stack 10 or distributedly disposed in both ends of the cell stack 10.

The terminal 11 may be fastened to a connection member 82 to be described later.

In the cell stack 10 of the present embodiment, the terminal 11 may be disposed to face in a downward direction, and may be seated in the case 50. To this end, the connection member 82 may be disposed on a bottom surface on which the cell stack 10 is seated in the case 50 to be described later. Therefore, in the battery device 1 of the present embodiment, the connection member 82 and the terminal 11 may be in contact with each other only by a process of seating the cell stack 10 in the case 50.

The case 50 may provide an accommodation space for accommodating other components therein. Therefore, the case 50 may be provided in a form entirely surrounding the cell stacks 10, and the plurality of cell stacks 10 may form a plurality of rows in the accommodation space of the case 50, and may be disposed side by side.

The case 50 may be formed of a metal material to ensure rigidity, but the disclosure of this patent document is not limited thereto. In addition, at least a portion of the case 50 may be formed of aluminum to increase a heat dissipation effect.

The case 50 may include a side wall portion 51 forming an internal space, a bottom plate 52 covering a bottom portion of the internal space, and a top plate 53 covering a top portion of the internal space.

The side wall portion 51 may form an external side surface of the case 50, and may define the internal space. Therefore, the cell stacks 10 may be accommodated in the internal space defined by the side wall portion 51, and may be seated on the bottom plate 52.

The bottom plate 52 may support a bottom surface of each of the cell stacks 10, and may cool each of the cell stacks 10 at the same time. Also, each of the cell stacks 10 according to the present embodiment may be fastened to the bottom plate 52. To this end, the bottom plate 52 may include a cooling portion 58 and a fastening portion 55.

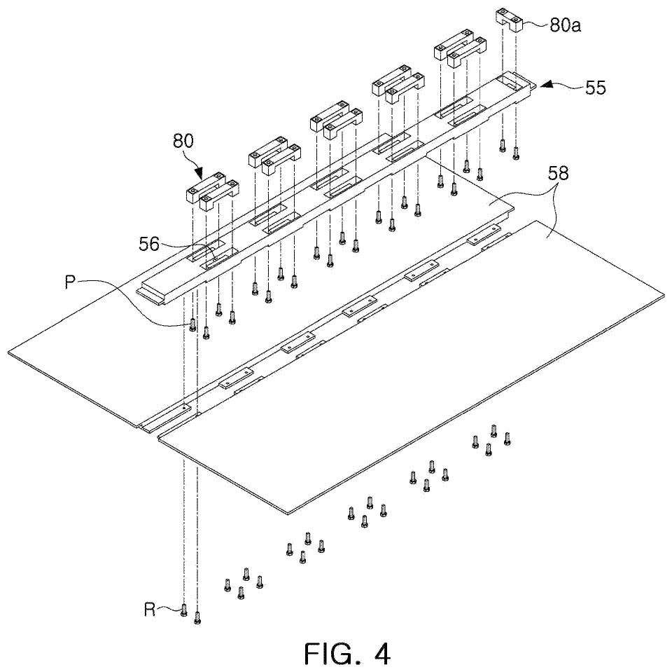

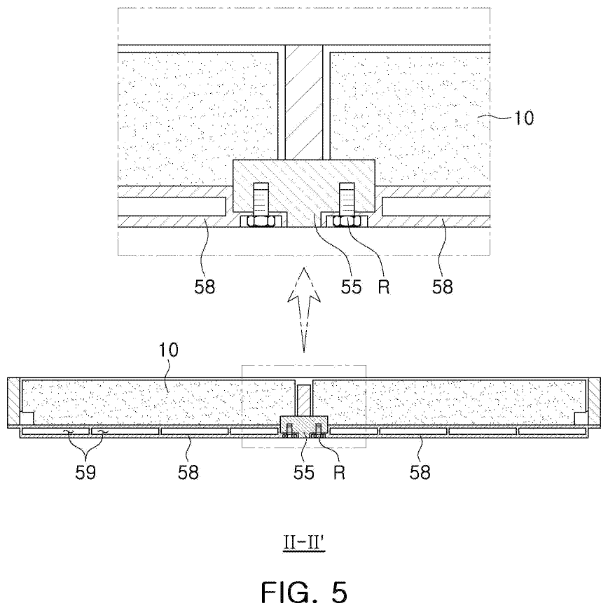

FIG. 4 is an exploded perspective view of the bottom plate illustrated in FIG. 3, and FIG. 5 is a cross-sectional view of FIG. 1, taken along line II-II′.

Referring to FIGS. 4 and 5 together, the cooling portion 58 may be disposed in a region facing the cell stack 10, and a plurality of cooling portions 58 may be distributed and disposed. The cooling portion 58 may include a cooling flow path 59 therein. Therefore, cooling flow path 59 may be connected to each other, or may have an inlet and an outlet, respectively, through which refrigerant flows in and out.

The fastening portion 55 may be coupled to at least one cooling portion 58. For example, the bottom plate 52 may be configured in a form in which the plurality of cooling portions 58 are fastened to at least one fastening portion 55. In the present embodiment, the fastening portion 55 may be formed to have a long bar shape, and the cooling portion 58 may be fastened to both sides of the fastening portion 55, respectively. A configuration of the disclosure of this patent document is not limited thereto. For example, various modifications are possible, such as forming the fastening portion 55 in a ‘+’ shape, disposing four cooling portions 58 in each partition space of the fastening portion 55 to combine them with each other, or the like. The fastening portion 55 may be also configured as a plurality of fastening portions 55. For example, the fastening portion 55 may be disposed in a bottom of the side wall portion 51. In this case, the fastening portion 55 may be configured as a plurality of fastening portions 55.

The fastening portion 55 may be formed to have a thickness similar to a thickness of the cooling portion 58, but the thickness of the fastening portion 55 may correspond to a shape of the cell stack 10, and the fastening portion 55 may be thicker than the cooling portion 58, as in the present embodiment.

In addition, as illustrated in FIG. 3, when the terminal 11 of the cell stack 10 is located on a level higher than that of a bottom surface of the cell stack 10, a top surface of the fastening portion 55 may be disposed on a level higher than that of a top surface of the cooling portion 58. Both end portions 83a of the connection member 82 disposed on the top surface of the fastening portion 55 may also be disposed on a level higher than that of the bottom surface of the cooling portion 58.

The fastening portion 55 and the cooling portion 58 may be coupled to each other through a fastening member R such as a bolt. For example, as illustrated in FIG. 5, the fastening portion 55 and the cooling portion 58 may be configured to partially overlap. In addition, the fastening member R may be fastened to the overlapping portion to couple the fastening portion 55 and the cooling portion 58 to each other. A configuration of the disclosure of this patent document is not limited thereto, and various methods may be used as necessary, such as integrating the fastening portion 55 and the cooling portion 58 by welding or the like.

At least one busbar assembly 80 may be disposed in the fastening portion 55.

The busbar assembly 80 may be a portion coupled to the terminal 11 of the cell stack 10, and may be disposed to contact the terminal 11 to electrically connect at least two cell stacks 10.

The busbar assembly 80 may be manufactured separately from the fastening portion 55, and may be coupled to the fastening portion 55. Therefore, the fastening portion 55 may be provided with an insertion groove 56 into which the busbar assembly 80 is inserted.

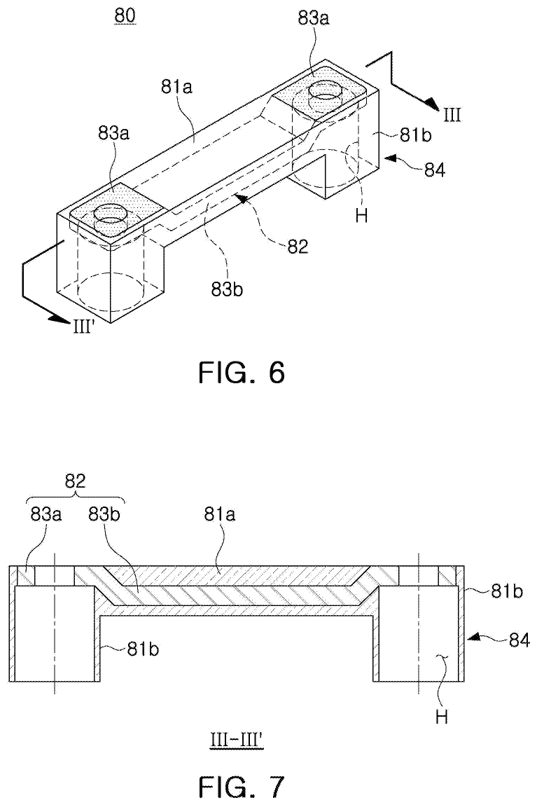

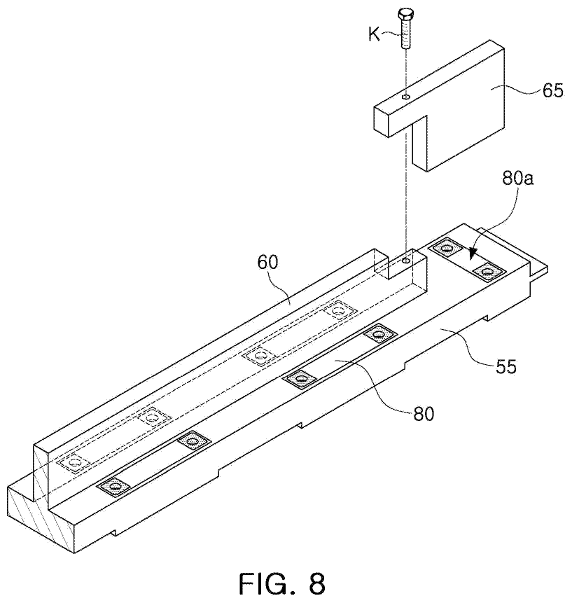

FIG. 6 is a perspective view of the busbar assembly illustrated in FIG. 4, and FIG. 7 is a cross-sectional view of FIG. 6, taken along line III-III′.

Referring to FIGS. 6 and 7 together, the busbar assembly 80 of the present embodiment may include a connection member 82 and an insulating body 84.

The connection member 82 may be formed of a conductive material, and may electrically connect a cell stack 10 and a terminal 11 of an adjacent cell stack 10 to each other. To this end, the connection member 82 may include a busbar or a cable. The both end portions 83a of the connection member 82 may be respectively fastened to the terminal 11 of the cell stack 10 through a fastening member P such as a bolt.

The cell stacks 10 of the present embodiment may be connected in series or parallel to each other through the connection member 82. Also, as necessary, some of the cell stacks 10 may be connected in series, and may be connected in parallel.

The connection member 82 according to the present embodiment may be formed by processing a conductive member having a flat rod shape. In addition, the connection member 82 may be formed of a flexible material. A configuration of the disclosure of this patent document is not limited thereto.

The both end portions 83a of the connection member 82 may be configured to be disposed on the same plane. In addition, a wiring portion 83b connecting both end portions 83a of the connection member 82 may be formed to be curved, and may be disposed on a plane, different from the above-mentioned plane.

The insulating body 84 may secure insulation between the connection member 82 and the fastening portion 55. To this end, the insulating body 84 may be formed of an electrically insulating material, and the insulating body 84 may be coupled to the connection member 82 to entirely surround the connection member 82. For example, the connection member 82 may be embedded in the insulating body 84 by an insert injection method, but is not limited thereto.

The insulating body 84 may include a member embedding portion 81a embedding the connection member 82, and insertion blocks 81b formed on both ends of the member embedding portion 81a and having a thickness, greater than a thickness of the member embedding portion 81a.

Since the connection member 82 may be embedded in the member embedding portion 81a, the member embedding portion 81a may be formed to be thicker than the connection member 82. In addition, in the connection member 82, only the end portion 83a may be exposed from the insulating body 84 externally, and the other portion thereof may be embedded in the insulating body 84.

To this end, the wiring portion 83b of the connection member 82 may be embedded in the member embedding portion 81a, and the both end portions 83a of the connection member 82 may be disposed in each of the insertion blocks 81b.

A through-hole H may be formed in the insertion block 81b of the insulating body 84. The both end portions 83a of the connection member 82 may be disposed in the through-hole H. Therefore, the both end portions 83a of the connection member 82 may be exposed from the insulating body 84 externally through the through-hole H.

The through-hole H may be used as a space into which a fastening member (P in FIG. 4) for fastening the busbar assembly 80 and the cell stack 10 is inserted. Therefore, the through-hole H may be formed to have a size in which the fastening member P is easily inserted.

As described above, since the busbar assembly 80 may be inserted into the insertion groove 56 of the fastening portion 55, the internal space of the insertion groove 56 will be formed to have a shape corresponding to an external shape of the busbar assembly 80. In addition, the insertion groove 56 may be formed to form a through-hole in a portion into which the insertion block 81b of the busbar assembly 80 is inserted. Therefore, when the busbar assembly 80 is inserted into the insertion groove 56, the through-hole H of the busbar assembly 80 may be exposed from a bottom portion of the fastening portion 55, and thus the busbar assembly 80 and the cell stack 10 may be fastened by inserting the fastening member P into the through-hole H in the bottom portion of the fastening portion 55.

The busbar assembly 80 configured as described above may electrically connect two cell stacks 10. Therefore, one end and the other end of the connection member 82 may be disposed in a bottom of different cell stacks 10.

As illustrated in FIGS. 1 and 2, the case 50 may include the partition wall (60 and 70) disposed to cross the internal space formed by the side wall portion 51 and partitioning the internal space into a plurality of accommodation spaces. Therefore, at least a portion of the partition wall (60 and 70) may be fastened to the side wall portion 51.

The partition wall (60 and 70) may reinforce overall rigidity of the case 50. In addition, the partition wall (60 and 70) may be disposed between the cell stacks 10 to suppress propagation of gas or flame between the cell stacks 10.

Specifically, the partition wall (60 and 70) may be disposed to cross between two cell stacks 10 disposed to face each other. Both ends of the partition wall (60 and 70) may be fastened to the side wall portions 51 of the case 50 or other partition wall (60 and 70), to partition the internal space formed by the side wall portions 51 into a plurality of accommodation spaces. Therefore, the plurality of cell stacks 10 may be distributedly disposed in the plurality of accommodation spaces partitioned by the side wall portion 51 and the partition wall (60 and 70).

Since the busbar assembly 80 of the present embodiment electrically connects the two cell stacks 10, both end portions 83a in one busbar assembly 80 may be respectively arranged in different accommodation spaces separated by the partition wall (60 and 70) from each other.

The partition wall (60 and 70) of the present embodiment may include at least one first partition wall 60 disposed in parallel with the width direction (Y-direction) of the cell stacks 10, and at least one second partition wall 70 disposed in parallel with the longitudinal direction (X-direction) of the cell stacks 10.

In the present embodiment, the terminal 11 may be disposed in one end side of the cell stack 10, based on the longitudinal direction. And one end on which the terminal 11 are disposed may be disposed adjacent to the first partition wall 60. Therefore, the busbar assembly 80 may be disposed in parallel with the first partition wall 60 on both sides of the first partition wall 60.

Also, in the present embodiment, the second partition wall 70 may be disposed between the cell stacks 10. Therefore, at least a portion of the second partition wall 70 may be disposed to cross the busbar assembly 80 in top of the busbar assembly 80. For example, the second partition wall 70 of the present embodiment may be coupled to the case 50, after the busbar assembly 80 is coupled to the fastening portion 55. As a result, the second partition wall 70 may be disposed in a top of the busbar assembly 80 to suppress movement of the busbar assembly 80, and thus the busbar assembly 80 may not be separated from the fastening portion 55 unless the second partition wall 70 is removed.

In an embodiment, at least one busbar assembly 80a of the busbar assemblies 80 may be disposed in a direction, intersecting the longitudinal direction of the first partition wall 60. Specifically, to electrically connect the cell stacks 10 accommodated in two accommodating spaces separated by the first partition wall 60, both end portions 83a of the connection member 82 in the above-described busbar assembly 80a may be respectively disposed in both sides of the first partition wall 60.

As described above, in the battery device 1 of the present embodiment, since each of the busbar assemblies 80 and 80a may be disposed to cross any one partition wall, there may not be a need to include a separate member for fixing the busbar assembly 80. A configuration of the disclosure of this patent document is not limited thereto, and is possible to omit the partition wall (60 and 70) is disposed in a top of the busbar assemblies 80 and 80a, as necessary.

When the cell stack 10 is fixed to the case 50 only by the fastening member P coupled to the terminal 11 of the cell stack 10, the other end side of the cell stack 10 may move damaged by external shock or shaking. Therefore, to stably fix the cell stack 10 in the accommodation space, at least one fastening block (40 in FIG. 2) may be provided in the accommodation space.

In the present embodiment, the fastening block 40 may be formed to protrude from the partition wall (60 and 70), the side wall portion 51, the bottom plate 52, or the like, and may include a fastening hole 41 to which a separate fastening member (Q in FIG. 2) such as a bolt is coupled.

The fastening block 40 may be disposed at a position spaced apart from the busbar assembly 80 by a predetermined distance, and may be disposed such that at least a portion thereof overlaps the cell stack 10. For example, the fastening block 40 may be inserted into and disposed in a bottom of the cell stack 10. To this end, a space having a groove shape in which the fastening block 40 is disposed may be provided on a bottom surface of the cell stack 10.

The cell stack 10 may be coupled to the fastening block 40 through the fastening member Q. In the present embodiment, the fastening member Q may be coupled to the fastening block 40 after passing through the cell stack 10 in a top of the cell stack 10. Therefore, in the cell stack 10 of the present embodiment, a through-hole 13 into which the fastening member Q is inserted may be formed in a portion corresponding to the fastening hole 41 of the fastening block 40.

A configuration of the disclosure of this patent document is not limited thereto, and is also possible to couple the fastening member Q to the bottom portion of the cell stack 10, instead of the top portion thereof. For example, it may also be configured that a through-hole is formed in a region of the cooling portion 58 in which the cooling flow path 59 is not formed, and a fastening member Q is inserted into the through-hole to couple the cell stack 10 to the fastening block 40.

The battery device 1 of the present embodiment may further include a cover 90 coupled to a through-hole H. The cover 90 may be coupled to the through-hole H to be detachable from a bottom side of the fastening portion 55. The cover 90 may be provided to prevent a foreign substance from entering the through-hole H. Therefore, as long as the cover 90 is stably fixed to the through-hole H, the cover 90 may be configured in various forms. For example, the cover 90 may be configured to be screwed or fitted into the through-hole H. In addition, it is also possible to configure to be coupled to a bottom end of the insertion groove 56, not the through-hole H.

In the battery device 1 of the present embodiment configured as described above, the terminal 11 of the cell stack 10 and the connection member 82 may be coupled to a bottom surface of the case 50. Therefore, since electrical connection may be minimized on a top side of the cell stack 10, a space between the cell stacks 10 may be maximized.

The above space may be used as a venting flow path (B in FIG. 3). For example, the venting flow path B may be formed as a space between the plurality of cell stacks 10 or a space between the plurality of cell stacks 10 and the case 50.

In the present embodiment, the venting flow path B may be used as a flow path through which explosion by-products such as gas are discharged from the cell stack 10 due to ignition of the battery cells to an external space of the battery device 1. Therefore, the above-described explosion by-products may be discharged to an external space of the case 50 through a venting hole 51a provided in the side wall portion 51 after moving toward the side wall portion 51 of the case 50 through the venting flow path B.

In other case in which a terminal 11 or a connection member 82 is disposed in a top side of a cell stack 10, the terminal 11 or the connection member 82 may be mostly exposed externally. Therefore, it may be easy to contact explosive by-products. Therefore, additional problems such as secondary explosions may occur. In addition, since the connection member 82 may be disposed in a venting flow path B, flow of gas may be obstructed, thereby reducing venting efficiency.

According to another embodiment, the terminal 11 and the connection member 82 may be located in a bottom of the cell stack 10. In the present embodiment, since the cell stack 10 may be coupled to the busbar assembly 80 to completely cover the both end portions 83a of the connection member 82, the terminal 11 or the connection member 82 may not be exposed from the cell stack 10 externally. Therefore, even when explosion by-products are generated, it is possible to prevent a short circuit from occurring between the terminal 11 due to the explosion by-products. In addition, since the connection member 82 may be embedded in the case 50, a maximum space may be provided between the cell stacks 10, and factors obstructing flow of gas may be minimized. Therefore, venting efficiency may increase.

The disclosure of this patent document is not limited to the above-described embodiment, and various modifications thereof are possible.

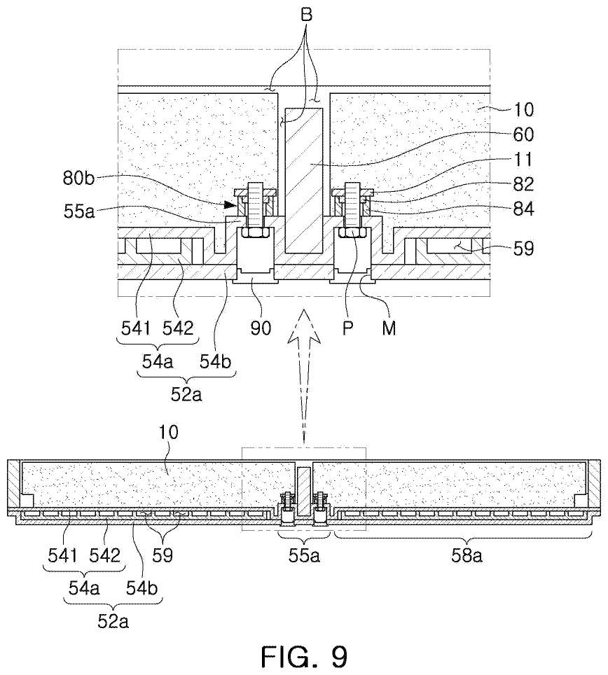

FIG. 8 is a perspective view partially illustrating a fastening portion and a partition wall according to another embodiment of the disclosure of this patent document.

Referring to FIG. 8, in a battery device according to the present embodiment, a first partition wall 60 and a fastening portion 55 may be integrally manufactured.

In this case, it may be difficult to dispose a busbar assembly 80a, as mentioned above, in a bottom of the first partition wall 60. Therefore, in the present embodiment, the first partition wall 60 may not be disposed in a top of the busbar assembly 80a. Therefore, in the battery device of the present embodiment, after the busbar assembly 80a is coupled to the fastening portion 55, an expansion partition wall 65 disposed in the busbar assembly 80a and coupled to the first partition wall 60 may be included. Therefore, the busbar assembly 80a may be disposed in a bottom of the expansion partition wall 65.

The expansion partition wall 65 may be disposed to extend a length of the first partition wall 60. Therefore, the expansion partition wall 65 may be formed to have the same thickness and the same height as the first partition wall 60. In addition, the expansion partition wall 65 may be disposed such that a portion thereof overlaps the first partition wall 60, and thus the expansion partition wall 65 may be attached and coupled to the first partition wall 60 by fastening a fastening member K to the overlapped portion.

In the present embodiment, a top portion of one side of the expansion partition wall 65 protrudes toward the first partition wall 60, and a top portion of one side of the first partition wall 60 may be concave and coupled to the protruding portion of the expansion partition wall 65. A configuration of the disclosure of this patent document is not limited thereto, and various modifications are possible as long as the expansion partition wall 65 is fixed. For example, it is also possible to fix and fasten the expansion partition wall 65 to the fastening portion 55 or a side wall portion (51 in FIG. 1), instead of the first partition wall 60.

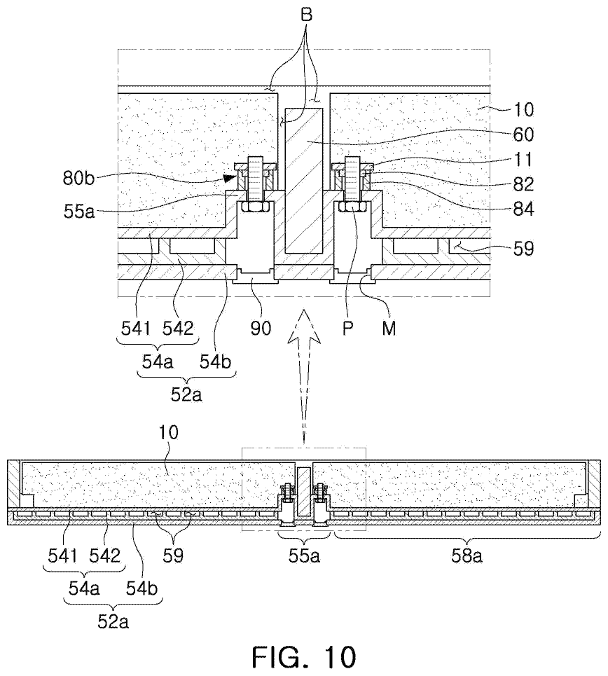

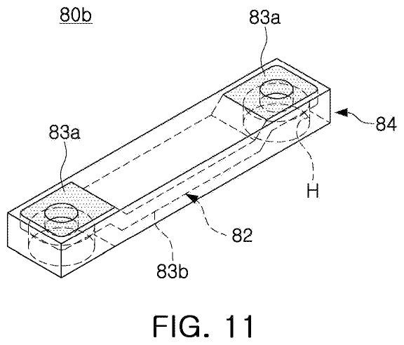

FIGS. 9 and 10 are cross-sectional views of a battery device according to another embodiment of the disclosure of this patent document, respectively. FIG. 11 is a perspective view of the busbar assembly illustrated in FIGS. 9 and 10.

Referring to FIGS. 9 and 10, a battery device of the present embodiment may be configured similarly to the battery device 1 of FIG. 1 described above, and may have a difference only in detailed configurations of a bottom plate 52a and a busbar assembly 80b. Therefore, detailed descriptions of components identical or similar to those of the above-described embodiment will be omitted, and description will mainly focus on differences in the bottom plate 52a and the busbar assembly 80b.

The lower plate 52a of the present embodiment may include a cooling plate 54a and a cover plate 54b. Also, the cooling plate 54a may include a first plate 541 and a second plate 542.

The first plate 541 may be a plate adjacent to a cell stack 10, and the second plate 542 may be a plate disposed in the first plate 541 in an outward direction and coupled to an external surface of the first plate 541.

The first plate 541 may support the cell stack 10, and thus at least a portion of the first plate 541 may be in direct contact with the cell stack 10. In addition, a heat conducting member may be inserted between the cell stack 10 and the first plate 541, as needed.

The busbar assembly 80b may be disposed in a portion of the first plate 541 facing a terminal 11 of the cell stack 10. For example, in the present embodiment, a fastening portion 55a may be located in a bottom of the terminal 11 of the cell stack 10 among the first plates 541, and may refer to a region to which the busbar assembly 80b is coupled or a region in which a cooling flow path 59 is not formed. Also, a cooling portion 58a may refer to a region in which the cooling flow path 59 is formed by coupling the second plate 542 to the first plate 541.

In the present embodiment, the fastening portion 55a may be formed such that a top surface thereof is entirely flat, and the busbar assembly 80b may be coupled to the top surface of the fastening portion 55a. A configuration of the disclosure of this patent document is not limited thereto, and various modifications are possible, such as forming a groove in the fastening portion 55a, disposing then the busbar assembly 80b in the groove, or the like, as in the above-described embodiment.

Similar to the foregoing embodiment, the top surface of the fastening portion 55a may be disposed on a level higher than that of a top surface of the cooling portion 58a. However, it may not be limited thereto, and various modifications are possible, such as arranging the top surface of the fastening portion 55a on the same plane as the top surface of the cooling portion 58a, or the like. In addition, considering a space to which a fastening member P is coupled, an empty space may be provided at a bottom of the fastening portion 55a. A shape of the fastening portion 55a may be formed by performing a drawing process for the first plate 541. However, a configuration of the disclosure of this patent document is not limited thereto.

A shape of the first plate 541 may be formed in various shapes, as illustrated in FIGS. 9 and 10. As long as the busbar assembly 80b coupled to the top surface is coupled to the terminal of the cell stack, the fastening portion 55a may be deformed to have various shapes. In addition, similar to the above-described embodiment, a first partition wall 60 may be coupled to the fastening portion 55a, and a second partition wall (70 in FIG. 2) may be disposed in the busbar assembly 80b.

The second plate 542 may be joined to a bottom surface, an external surface of the first plate 541. In this case, the entire surface of the second plate 542 may not be joined, but only a portion thereof, and at least a portion of the unjoined portion may be spaced apart from the first plate 541. A space between the first plate 541 and the second plate 542 formed as a result may be used as the cooling flow path 59.

In the present embodiment, the fastening member P may be inserted into a bottom portion of the fastening portion 55a, may pass through the first plate 541, and then the busbar assembly 80b and the cell stack 10 may be fastened. Therefore, the second plate 542 may not be coupled to a portion of the first plate 541 divided into the fastening portion 55a, and thus the cooling flow path 59 may not be disposed in a portion corresponding thereto. However, a configuration of the disclosure of this patent document is not limited thereto.

The busbar assembly 80b of the present embodiment may include a connection member 82 and an insulating body 84, in a similar manner to the above-described busbar assembly 80b. Since the insertion groove (56 in FIG. 4) of the above-described embodiment is not formed in the fastening portion 55a of the present embodiment, in the busbar assembly 80b of the present embodiment, the insulating body 84 may be entirely formed to have the same thickness, as illustrated in FIG. 11.

The cover plate 54b may be disposed outside the second plate 542, and may be fastened to the side wall portion to support the cooling plate 54a. The cover plate 54b may entirely cover the entire cooling plate 54a, and may be fastened to the side wall portion 51.

The cover plate 54b may further include a cover 90 coupled to a position corresponding to a bottom space of the fastening portion 55a. The cover 90 may be coupled to the cover plate 54b such that the cover plate 54b is detachable from a bottom side, and a hole M to which the cover 90 is coupled may be used as a path into which the fastening member P is inserted to face the fastening portion 55a.

As in the above-described embodiment, the cover 90 may be provided to prevent a foreign substance from being introduced into the cover plate 54b. Therefore, the cover 90 may be configured in various forms, as long as the cover 90 is stably fixed to the hole M of the cover plate 54b. For example, the cover 90 may be configured to be screwed or forcedly fitted into the hole M.

When the cover plate 54b is coupled to the side wall portion 51 after the fastening member P is fastened to the fastening portion 55a, the busbar assembly 80b, and the terminal 11, the hole M of the cover plate 54b and the cover 90 may be omitted.

Although embodiments of the disclosure of this patent document have been described in detail above, it will be obvious to those skilled in the art that the scope of the disclosure of this patent document is not limited thereto, and various modifications and variations are possible without departing from the technical spirit of the disclosure of this patent document described in the claims.

For example, it may be implemented by deleting some components from the above-described embodiments, and each embodiment may be implemented in combination with each other.

According to an embodiment of the disclosure of this patent document, a terminal of a cell stack and a connection member may be coupled to each other on a bottom surface of a case. Therefore, it is possible to minimize occurrence of a short circuit on a top side of the cell stack. In addition, since a maximum space between cell stacks may be secured, a venting flow path may be expanded.

Only specific examples of implementations of certain embodiments may be described. Variations, improvements and enhancements of the disclosed embodiments and other embodiments may be made based on the disclosure of this patent document.

What is claimed is:

1. A battery device comprising:
a plurality of cell stacks formed by stacking a plurality of battery cells and including terminal for external connection;
a case accommodating the plurality of cell stacks therein; and
at least one busbar assembly contacting the terminal of the plurality of cell stacks to electrically connect the plurality of cell stacks to each other,
wherein the at least one busbar assembly is disposed in a bottom surface of the case, and
wherein the plurality of cell stacks, having a bottom surface on which the terminal is disposed, is coupled to the busbar assembly.

2. The battery device of claim 1, wherein the busbar assembly comprises:
a connection member formed of a conductive material and having both end portions contacting terminal of different cell stacks of the plurality of cell stacks; and
an insulating body embedding the connection member therein,
wherein only the both end portions of the connection member are exposed from the insulating body externally to contact the terminal.

3. The battery device of claim 2, wherein the case comprises:
a side wall portion forming an internal space; and
a bottom plate covering a bottom portion of the internal space, and
wherein the bottom plate includes a cooling plate including a first plate supporting the plurality of cell stacks, and a second plate coupled to the first plate to form a cooling flow path.

4. The battery device of claim 3, wherein the cooling plate comprises:
a fastening portion to which the at least one busbar assembly is coupled; and
a cooling portion in which the cooling flow path is formed.

5. The battery device of claim 3, wherein the bottom plate further comprises a cover plate supporting a bottom portion of the cooling plate and coupled to the side wall portion.

6. The battery device of claim 4, further comprising a partition wall partitioning the internal space into a plurality of accommodation spaces,
wherein the partition wall is coupled to the fastening portion.

7. The battery device of claim 3, further comprising a partition wall partitioning the internal space into a plurality of accommodation spaces,
wherein the partition wall crosses the busbar assembly and the partition wall is disposed in a top of the busbar assembly.

8. The battery device of claim 2, further comprising a venting flow path through which gas moves when the gas is discharged from the plurality of battery cells,
wherein the venting flow path is formed as a space between the plurality of cell stacks or between the plurality of cell stacks and the case.

9. The battery device of claim 2, wherein the plurality of cell stacks are coupled to the busbar assembly to completely cover the both end portions of the connection member.

10. The battery device of claim 4, wherein a top surface of the fastening portion is disposed on a level higher than that of a top surface of the cooling portion.

11. The battery device of claim 4, wherein the both end portions of the connection member are disposed on a level higher than that of a top surface of the cooling portion.

12. The battery device of claim 6, further comprising an expansion partition wall coupled to the partition wall and extending a length of the partition wall,
wherein the busbar assembly is disposed in a bottom of the expansion partition wall.

13. The battery device of claim 6, further comprising:
a fastening block disposed in the internal space, and disposed to overlap at least a portion thereof with the plurality of cell stacks; and
a fastening member passing through the plurality of cell stacks and fastened to the fastening block.

14. The battery device of claim 2, wherein the case comprises:
a side wall portion forming an internal space; and
a bottom plate covering a bottom portion of the internal space,
wherein the bottom plate includes:
at least one cooling portion having a cooling flow path therein; and
a fastening portion coupled to the at least one cooling portion and the cooling portion having an insertion groove into which the busbar assembly is inserted.

15. The battery device of claim 14, wherein the busbar assembly comprises a member embedding portion in which the connection member is embedded, and the busbar assembly comprises insertion blocks formed thicker than the member embedding portion on both ends of the member embedding portion,
wherein a through-hole is formed in each of the insertion blocks, and the both end portions of the connection member are disposed in different through-holes and exposed from the insulating body externally.

16. The battery device of claim 15, further comprising a fastening member inserted into the through-hole from a bottom portion of the fastening portion and fastening the connection member to each of the terminal.

17. The battery device of claim 15, wherein, in the connection member, the both end portions are disposed on the same plane, and a portion embedded in the member embedding portion is disposed on a plane different from the both end portions.

18. The battery device of claim 2, wherein the connection member is formed of a material having flexibility.

19. The battery device of claim 2, wherein the connection member comprises a wiring portion connecting the both end portions,
wherein the wiring portion is formed to be curved.

20. The battery device of claim 4, wherein the cooling portion is provided as a plurality of cooling portions, and the plurality of cooling portions are disposed in a space partitioned by the fastening portion.
